(19) United States
(12) Patent Application Publication
(10) Pub. No.: US 2025/0135979 A1
(43) Pub. Date: May 1, 2025

(54) FLOOR MAT HOOK FOR VEHICLE

(71) Applicant: DAEHAN SOLUTION CO., LTD., Incheon (KR)

(72) Inventors: CHOONG HO KWON, SEOUL (KR); JUN-HO PARK, INCHEON (KR)

(21) Appl. No.: 18/909,491

(22) Filed: Oct. 8, 2024

(30) Foreign Application Priority Data
Oct. 31, 2023 (KR) 10-2023-0147444

(51) Int. Cl. B60N 3/04

(52) U.S. Cl. CPC B60N 3/046

(57) ABSTRACT

In the present invention, a fixing plate formed on a base passes through and is inserted into an assembly hole formed in a floor carpet, and a passing portion of the fixing plate is rotated to be fixedly hooked on a step. Accordingly, the number of components is reduced to one, and thus everyone can easily and conveniently perform assembly and safely and conveniently use a floor mat. Particularly, in the present invention, a hooking operation is performed by hooking a portion of an edge which is a rotary center of a fixing plate that is bent as described above and portions of two edges in contact with the edge on steps so that the fixing plate can be more firmly and

### CROSS-REFERENCE TO RELATED APPLICATION

This application claims priority to and the benefit of Korean Patent Application No. 10-2023-0147444, filed Oct. 31, 2023, the disclosure of which is incorporated herein by reference in its entirety.

### BACKGROUND

### 1. Field of the Invention

The present invention relates to a floor mat hook for a vehicle, and more specifically, to a floor mat hook for a vehicle, in which two fixing plates formed on a base are inserted into assembly holes formed in a floor carpet, the fixing plates are rotated and bent to be in close contact with a surface of the floor carpet, and elastic steps are hooked on hooking steps at three locations so that not only can everyone easily and simply perform assembly without using a tool, but assembly processes are also reduced by simplifying components. In addition, as a hooking operation is performed at portions of edges for rotatably supporting the fixing plates and two edges adjacent to the edges, the fixing plates are more firmly supported.

### 2. Discussion of Related Art

By spreading a floor mat on a floor carpet of a vehicle, the floor carpet is protected from coming in direct contact with dust that falls from above, foreign matter stuck to shoes, rainwater, etc., kept clean, and allowed to be easily and conveniently cleaned.

Technologies for mounting a floor mat on a floor carpet are disclosed in Patent Documents 1 to 3 below.

### (Patent Document 1) Korean Registered Patent No. 10-2290211

A base and a fixing member are provided to face and be engaged with each other, and a hooking protrusion is hooked on the fixing member to be assembled together when a through protrusion formed on the fixing member passes through and is assembled with a floor carpet and the base, thereby firmly fixing a floor mat hook to the floor carpet, and the floor mat hook can be safely used because the floor mat hook is not disconnected or separated from the floor carpet. Particularly, as at least one pressing protrusion is formed to protrude from a surface of the base facing the floor carpet, the pressing protrusion allows the floor mat hook to be more firmly and fixedly inserted into the floor carpet when the floor mat hook is assembled. In addition, as the base and the fixing member are formed to be integrally connected through a soft portion, the floor mat hook for a vehicle may be injection-molded at nce, and thereby the floor mat hook can be easily manufactured, conveniently used, and firmly fixed to the floor carpet.

### (Patent Document 2) Korean Registered Patent No. 10-2105481

This is related to providing a mat hook which is easily attached to or detached from a mat and of which deformation due to detachment or an external pressure is prevented. According to one embodiment of the content disclosed in the present specification, the mat hook includes a hook body formed in close contact with an upper portion of the mat, a pressing part of which one end is coupled to one end of the hook body and the other end extends downward, a first fastening part protruding from a lower surface of the other end of the hook body, and a second fastening part protruding from a lower surface of one end of the hook body, the other end of the pressing part passes through the first fastening part and then is hooked on and coupled to the first fastening part by elastically bending one end of the pressing part, and the second fastening part passes through the pressing part, and then is hooked on and coupled to the pressing part.

### (Patent Document 3) Korean Registered Patent No. 10-1362056

This is related to an auxiliary mat fixing hook device for a vehicle, and the auxiliary mat fixing hook device for a vehicle, which fixes an auxiliary mat to a carpet attached to an interior floor panel of a vehicle, includes a carpet clip unit installed in a carpet upper retainer and a carpet lower retainer on the carpet and provided with a hook body rotatably installed in the carpet upper retainer and a mat clip unit which is installed in a mat upper retainer and a mat lower retainer on the auxiliary mat and in which a hook of the hook body is fitted into a hook fixing groove of the mat upper retainer in a state in which the hook body is fitted into the mat upper retainer so that the mat clip unit is fixed to the carpet clip unit.

### RELATED ART

### Patent Documents

(Patent Document 1) Korean Registered Patent No. 10-2290211 (Registration date: Aug. 10, 2021)
(Patent Document 2) Korean Registered Patent No. 10-2105481 (Registration date: Apr. 22, 2020)
(Patent Document 3) Korean Registered Patent No. 10-1362056 (Registration date: Feb. 3, 2021)

### SUMMARY OF THE INVENTION

However, there are following inconveniences when an existing hook device for fixing a floor mat is fixed to a floor carpet.
(1) Since a structure is complex, it is difficult to fix a hook device to a floor carpet.
(2) In addition, since the number of components is large, when assembly is performed in a different order from an assembly order when the hook device is mounted on the floor carpet, a floor mat can be easily taken off or the hook device can be easily separated and damaged due to poor assembly.
(3) Particularly, in the conventional hook device, assembly should be performed while a floor mat board is applied to stably support a base part. However, when the floor mat board is not applied during the assembly, there is a possibility of the hook device being unhooked or damaged because an external force applied to the base part is not dispersed.
(4) Therefore, since the floor mat board should be additionally manufactured, not only does a manufacturing cost increase accordingly, but the number of processes also increases in an assembly process.

The present invention is disclosed in consideration of the above problems and is directed to providing a floor mat hook for a vehicle, in which a fixing plate formed on a base passes through and is inserted into an assembly hole formed in a floor carpet, and a passing portion of the fixing plate is rotated to be fixedly hooked on a step. Accordingly, the number of components is reduced to one, and thus everyone can easily and conveniently perform assembly and safely and conveniently use a floor mat.

Particularly, the present invention is also directed to providing a floor mat hook for a vehicle, in which a hooking operation is performed by hooking a portion of an edge which is a rotary center of a fixing plate bent as described above and portions of two edges in contact with the edge on steps so that the fixing plate is more firmly and fixedly supported through three-point fixing supporting.

In addition, the present invention is also directed to providing a floor mat hook for a vehicle, in which a portion of a step formed on a portion which is a rotary center, when a fixing plate is rotated to hook a step on the step, is formed to be rounded such that the fixing plate is forcibly rotated and hooked on the step.

According to an aspect of the present invention, there is provided a floor mat hook for a vehicle, including a base (100) used with a hook (110) formed on one surface to hook a floor mat (M) and the other surface fixed to a floor carpet (C), wherein the base (100) includes two fixing plates (120) formed on a surface of the base (100), on which the hook (110) is not formed, installed to face each other with a predetermined space therebetween, and integrally formed to be spaced a predetermined distance from the surface of the base (100) and rotated in opposite directions, a first hooking step (121) is formed by cutting a central portion of an edge of each of the fixing plates (120) in contact with the base (100), second hooking steps (122) are formed on two edges of the fixing plate (120) adjacent to the first hooking step (121), and a first elastic step (130) and second elastic steps (140) are formed on the base (100), wherein the first elastic step (130) is hooked on the first hooking step (121) and the second elastic steps (140) are hooked on the second hooking steps (122) by rotating the fixing plate (120) to a position parallel to the surface of the base (100).

Particularly, in the second hooking steps (122) and the second elastic steps (140), edge portions facing each other may be formed to be rounded to forcibly pass each other.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view illustrating a portion of a floor carpet on which a floor mat hook for a vehicle is mounted according to the present invention;

FIG. 2 is a cross-sectional view illustrating a state in which the floor mat hook for a vehicle is mounted on the floor carpet according to the present invention;

A set of FIG. 3A and FIG. 3B are views illustrating entire shapes of the floor mat hook for a vehicle according to the present invention, wherein FIG. 3A is a front perspective view and FIG. 3B is a rear perspective view;

A set of FIG. 4A and FIG. 4B are views illustrating state before the floor mat hook for a vehicle is inserted to be assembled with the floor carpet according to the present invention, wherein FIG. 4A is a perspective view and FIG. 4B is a cross-sectional view;

FIG. 5 is a cross-sectional view illustrating a state in which a fixing plate inserted into the floor carpet is rotated to be fixed to the floor carpet according to the present invention; and

FIG. 6 is a cross-sectional view illustrating a state in which a floor mat is hooked on the floor mat hook fixed to the floor carpet according to the present invention.

### DETAILED DESCRIPTION OF EXEMPLARY EMBODIMENTS

Hereinafter, exemplary embodiments of the present invention will be described in more detail with reference to the accompanying drawings. Moreover, terms and words used in the present specification and claims should not be interpreted as being limited to commonly used meanings or meanings in dictionaries and should be interpreted as having meanings and concepts which are consistent with the technological scope of the invention based on the principle that the inventors have appropriately defined concepts of terms in order to describe the invention in the best way.

Therefore, since the embodiments described in this specification and components illustrated in the drawings are only exemplary embodiments and do not represent the overall technological scope of the invention, it should be understood that there may be various equivalents or modifications substituting the exemplary embodiments at the time of filing of this application.

### Structure of Floor Mat Hook for Vehicle

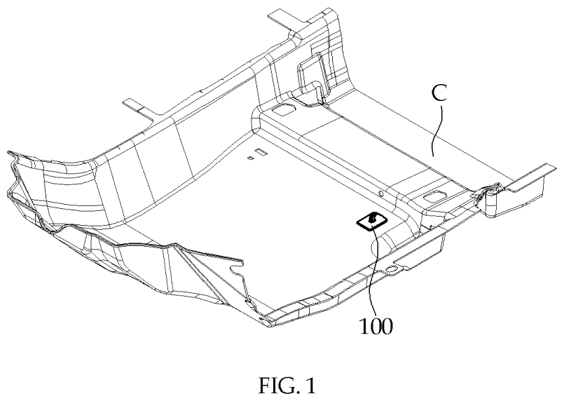

As illustrated in FIGS. 1 to 6, a floor mat hook for a vehicle according to the present invention includes a base 100 which is used with a hook 110 formed on one surface to hook a floor mat M and the other surface fixed to a floor carpet C.

Particularly, two fixing plates 120 installed to pass through the floor carpet C are formed on a surface of the base 100 facing the floor carpet C, and passing portions of the fixing plates 120 facing each other are bent to move away from each other and be hooked on steps so that the base 100 is fixed to the floor carpet C, and thereby the floor mat hook can be easily manufactured and assembly can be conveniently performed to improve assembly efficiency.

In this case, the fixing plate 120 is provided to be fixed to the floor carpet C while bent and hooked on the steps at three locations, thereby maintaining a state in which the base 100 is firmly fixed to the floor carpet C.

Hereinafter, such a structure will be described in more detail with reference to the accompanying drawings.

### A. Base

As illustrated in FIGS. 1 to 3B, the hook 110 is formed to protrude from one surface of the base 100. The hook is used to fixedly hook the floor mat M in a state in which the base 100 is fixed to the floor carpet C.

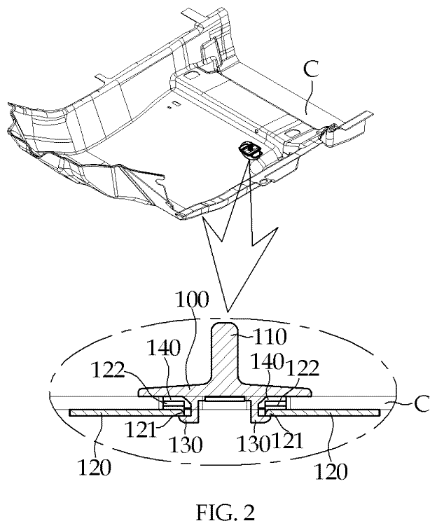

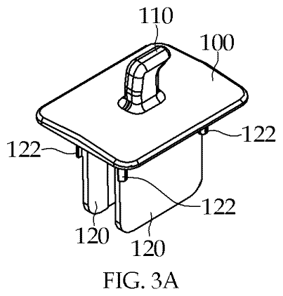

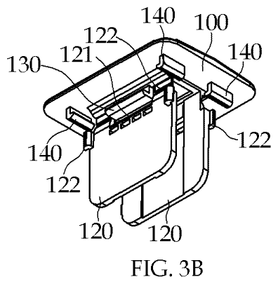

Meanwhile, as illustrated in FIGS. 2 to 4B, the two fixing plates 120 are installed to integrally protrude and pass through the floor carpet C from a surface of the base 100 on which the hook 110 is not formed.

### B. Fixing Plate

As illustrated in FIGS. 2 to 6, the two fixing plates 120 are formed to protrude to face each other from the surface of the base 100 on which the hook 110 is not formed. In this case, the fixing plates 120 are integrally formed on the surface of the base 100 to rotate away from each other in opposite directions and are formed on the surface of the base 100 to rotate in place while separated by a predetermined thickness, preferably, a thickness in which the floor carpet C can be inserted. In addition, the fixing plate 120 may be provided to rotate on the surface of the base 100 using a pin or protrusion, or the fixing plate 120 may be provided to rotate through a soft portion manufactured such that a thickness of a portion which is a rotary center is smaller than that of another portion. However, it is preferable that the fixing plate 120 be integrally manufactured with the base 100 using the soft portion.

Meanwhile, as illustrated in FIGS. 2 to 4B, first hooking steps 121 and second hooking steps 122 are formed on the fixing plates 120 to be fixedly step-hooked after being rotated to be parallel to the base 100.

### 1. First Hooking Step

As illustrated in FIGS. 2 to 4B, the first hooking step 121 is formed by partially cutting a central portion of an edge portion which is near to the rotary center of the fixing plate 120.

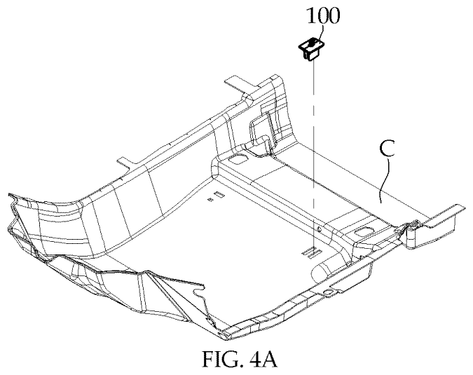

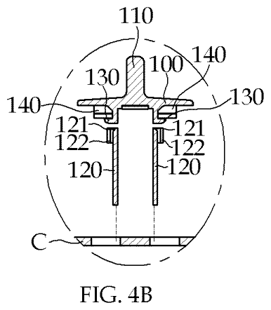

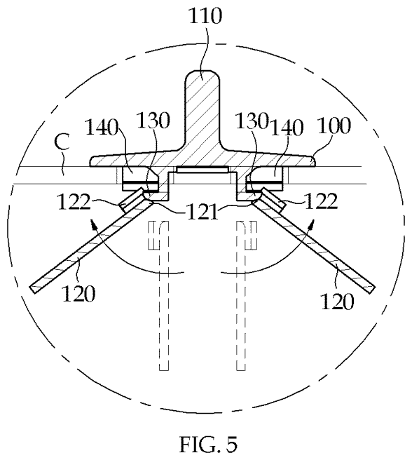

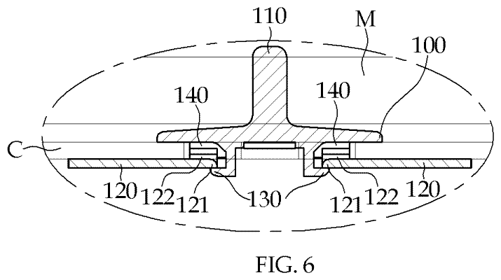

In this case, as illustrated in FIGS. 5 and 6, as portions of the fixing plates 120 protruding to pass through the floor carpet C are rotated away from each other, the first hooking steps 121 come into contact with first elastic steps 130, forcibly pass over the first elastic steps 130, and are step-hooked. Accordingly, it is preferable that edge portions, which come into contact with each other as described above, of the first hooking steps 121 and the first elastic steps 130 which will be described below be smoothly roundly formed such that passing over is forcibly performed with a predetermined force.

In addition, a plurality of holes may be formed in the edge portion on which the first hooking step 121 is formed along an edge. The holes allow the edge portion serving as the first hooking step 121 to be easily deformed and return to an original state when the first hooking step 121 forcibly passes over the first elastic step 130 so that assembly is conveniently and quickly performed, and step-hooking is firm after returning.

### 2. Second Hooking Step

As illustrated in FIGS. 2 to 6, the second hooking steps 122 are steps formed on edges disposed at two sides of edges on which the first hooking steps 121 are formed. This allows the fixing plate 120 to be rotated to hook the first hooking steps 121 on the first elastic steps 130 and to hook the second hooking steps 122 on second elastic steps 140 at the same time so that the fixing plate 120 is hooked on three steps. Accordingly, the hooking of the fixing plate 120 is not easily released, and the fixing plate 120 firmly supports a bottom of the floor carpet C.

As illustrated in FIGS. 2 to 6, the first hooking steps 121 and the second hooking steps 122 formed as described above are step-hooked on the first and second elastic steps 130 and 140 which will be described below.

### C. First and Second Elastic Steps

As illustrated in FIGS. 3A to 6, the first and second elastic steps 130 and 140 are formed to protrude from the base 100 on which the fixing plates 120 are formed.

In this case, as illustrated in FIGS. 3A to 6, the first and second elastic steps 130 and 140 are formed at locations at which the first hooking steps 121 are hooked on the first elastic steps 130 and the second hooking steps 122 are hooked on the second elastic steps 140 by rotating passing portions of the fixing plates 120 in a state in which the fixing plates 120 pass through and are inserted into an assembly hole formed in the floor carpet C.

In this case, it is preferable that the first and second elastic steps 130 and 140 be slightly elastically deformed and then return to their original states when step-hooking is performed. However, it is further preferable that not only the first and second elastic steps 130 and 140 but also the first and second hooking steps 121 and 122 be elastically deformed when the step-hooking is performed.

Meanwhile, in the exemplary embodiment of the present invention, as illustrated in FIG. 6, as the first and second elastic steps 130 and 140 are formed such that the fixing plates 120 are positioned at positions parallel to the base 100 when the first and second hooking steps 121 and 122 are step-hooked thereon, the floor carpet C is integrally fixedly inserted between the base 100 and the fixing plates 120.

As described above, in the present invention, the fixing plates pass through and are fitted into the floor carpet, the passing portions of the fixing plates are rotated away from each other in opposite directions to perform step-hooking, and the portions of the fixing plates are in close contact with a surface of the floor carpet to fix the floor carpet hook, so that the structure is simple, and everyone can easily perform the assembly and conveniently and safely use the floor carpet hook.

A floor mat hook for a vehicle according to the present invention has the following effects.

(1) Two fixing plates, which are formed on a surface of a base facing a floor carpet, pass through the floor carpet, passing portions are bent and rotated parallel to the surface of the base to be fixedly hooked on steps, and thereby assembly can be easily, conveniently, and quickly performed using the floor mat hook.

(2) As one floor mat hook is formed as described above, since a component such as a plate for maintaining a uniform flat surface of the floor carpet does not need to be additionally manufactured, not only can the number of components be reduced, but a cost can also be reduced accordingly.

(3) In addition, since the fixing plates, which are bent toward two sides, both remain bent while hooked on three steps, the floor carpet is located between the fixing plates and the base so that stable and fixedly supportive assembly can be performed, and the floor mat hook can be conveniently used.

(4) In this case, as the steps are formed to forcibly pass and be hooked on one another, everyone can easily and conveniently perform assembly.

What is claimed is:

1. A floor mat hook for a vehicle, comprising a base (100) used with a hook (110) formed on one surface to hook a floor mat (M) and the other surface fixed to a floor carpet (C),
wherein the base (100) includes two fixing plates (120) formed on a surface of the base (100), on which the hook (110) is not formed, installed to face each other with a predetermined space therebetween, and integrally formed to be spaced a predetermined distance from the surface of the base (100) and rotated in opposite directions,
a first hooking step (121) is formed by cutting a central portion of an edge of each of the fixing plates (120) in contact with the base (100),
second hooking steps (122) are formed on two edges of the fixing plate (120) adjacent to the first hooking step (121), and
a first elastic step (130) and second elastic steps (140) are formed on the base (100),
wherein the first elastic step (130) is hooked on the first hooking step (121) and the second elastic steps (140) are hooked on the second hooking steps (122) by rotating the fixing plate (120) to a position parallel to the surface of the base (100).

2. The floor mat hook of claim 1, wherein, in the second hooking steps (122) and the second elastic steps (140), edge portions facing each other are formed to be rounded to forcibly pass each other.
